(19) United States
(12) Patent Application Publication
(10) Pub. No.: US 2016/0343510 A1
(43) Pub. Date: Nov. 24, 2016

(54) Capacitor With Various Capacitances

(71) Applicant: Beijing Yuan Liu Hong Yuan Electronic Technology Co., Ltd., Beijing (CN)

(72) Inventors: Hongyan DU, Beijing (CN); Renzheng CHEN, Beijing (CN); Shuying SUN, Beijing (CN)

(21) Appl. No.: 14/886,869

(22) Filed: Oct. 19, 2015

(30) Foreign Application Priority Data
May 19, 2015 (CN) 201510257394.3

(51) Int. Cl. H01G 5/011; H01G 5/013

(52) U.S. Cl. CPC H01G 5/011; H01G 5/0134

(57) ABSTRACT

The present invention relates to a capacitor with various capacitances, comprising dielectric sheets, outer electrodes, and inner electrodes, printed on said dielectric sheets, wherein said dielectric sheets are overlapped, the odd layers of said dielectric sheets are first dielectric sheets, and the even layers of said dielectric sheets are second dielectric sheets, an inner electrode on said first dielectric sheet and/or an inner electrode on said second dielectric sheet is divided into at least two isolated electrodes, each electrode on said first dielectric sheet and said second dielectric sheet is leaded respectively to form terminal electrodes, and said terminal electrodes are encapsulated to form the outer electrodes. Thus, different outer electrodes for wiring can be selected according to the needs for capacitor capacitances, in order to provide various capacitances, only by changing wiring on one capacitor, which can meet the requirements of customers for different capacitances, with a good versatility, and a wide application range; meanwhile, such a capacitor can replace several capacitors in a circuit, which greatly reducing the size of the circuit board and the user's inventory pressure.

### CROSS-REFERENCE TO RELATED APPLICATIONS

Pursuant to 35 U.S.C. §119 and the Paris Convention Treaty, this application claims the benefit of Chinese Patent Application No. 201510257394.3 filed on May 19, 2015, the content of which is incorporated herein by reference.

### BACKGROUND OF THE INVENTION

1. Field of the Invention

The present invention relates to the technical field of electronic component, especially relates to a capacitor with various capacitances.

2. Description of the Related Art

The electronic components are required to be more and more “light, thin, short, small” and reliable in the electronic components market. A multi-layer ceramic capacitor has been widely used in various fields because of the advantages of small volume, low loss and high reliability.

At present, the multi-layer ceramic capacitor mainly comprises two terminals capacitor and three terminals capacitor. Wherein, the structure of multi-layer ceramic capacitor with two terminals is that, the ceramic dielectric sheets with printed inner electrodes are overlapped in the way of dislocation, two terminal electrodes are leaded from both ends of a chip alternately, and the electrode (outer electrode) is sealed with a metal layer, in order to form the multi-layer ceramic capacitor with two terminals. Most of the multi-layer ceramic capacitor with three terminals are multi-layer ceramic double capacitor, as shown in FIG. 1, the structure of the capacitor is that: the ceramic dielectric sheets with printed longer terminal electrodes and the ceramic dielectric sheets with shorter terminal electrodes are overlapped (the shorter terminal electrode has a cross-shaped structure), three terminal electrodes are leaded from both ends and side surface of a chip alternately, the electrode (outer electrode) is sealed with a metal layer, in order to form the multi-layer ceramic capacitor with three terminals. The present multi-layer ceramic capacitor with two terminals and multi-layer ceramic capacitor with three terminals only have one capacitance, which directly leads to a limited application scope and a poor versatility of the multi-layer ceramic capacitor in the prior art during use, and the user needs to stock capacitors with various capacitances. Especially in some decoupling and filter circuits, which needs a combination of capacitors with various capacitances, and leads to place several capacitors on a circuit board, which is not conducive to narrowing the size of the circuit board.

### SUMMARY OF THE INVENTION

One object of the present invention is to provide a capacitor with various capacitances, comprising dielectric sheets, outer electrodes, and inner electrodes, printed on the dielectric sheets, wherein the dielectric sheets are arranged in overlapped manner, odd layers of the dielectric sheets are defined as first dielectric sheets, and even layers of the dielectric sheets are defined as second dielectric sheets, an inner electrode on the first dielectric sheet and/or an inner electrode on the second dielectric sheet is divided into at least two isolated electrodes, each electrode on the first dielectric sheet and the second dielectric sheet is leaded respectively to form terminal electrodes, and the terminal electrodes are encapsulated to form the outer electrodes.

In a class of embodiment, an inner electrode on the first dielectric sheet is divided into two isolated electrodes.

In a class of embodiment, an inner electrode on the first dielectric sheet is divided into two isolated electrodes with different lengths.

In a class of embodiment, the total length of the inner electrode printed on the first dielectric sheet is larger than that of the inner electrode printed on the second dielectric sheet.

In a class of embodiment, the two isolated electrodes printed on the first dielectric sheet are leaded from the terminals of the capacitor in the length direction towards both ends of the length direction.

In a class of embodiment, the inner electrode printed on the second dielectric sheet is leaded from the waist portion of the capacitor in the length direction towards both ends of the width direction.

In a class of embodiment, the inner electrode printed on the second dielectric sheet has a cross-shaped structure.

In a class of embodiment, the first dielectric sheet and the second dielectric sheet are ceramic dielectric sheets.

In a class of embodiment, the outer electrode comprises a base metal layer, a barrier layer, and a weldable layer from the inside to the outside.

Comparing with the prior art, the above technical solutions of the present invention have following advantages:

The capacitor with various capacitances provided in the present invention, the inner electrode on the first dielectric sheet and/or an inner electrode on the second dielectric sheet is divided into at least two isolated electrodes, each electrode on the first dielectric sheet and the second dielectric sheet is leaded respectively to form terminal electrodes, and the terminal electrodes are encapsulated to form the outer electrodes. Thus, different outer electrodes for wiring can be selected according to the needs for capacitor capacitances, in order to provide various capacitances, only by changing wiring on one capacitor, which can meet the needs of customers for different capacitances, with a good versatility, and a wide application range; meanwhile, since various capacitances are achieved on one capacitor, thus, such a capacitor can replace several capacitors in the circuit, which greatly reducing the size of the circuit board and the user's inventory pressure.

### BRIEF DESCRIPTION OF THE DRAWINGS

In order to make the present invention easier to be clearly understood, the invention will be described in detail with references to the embodiments and the drawings, wherein:

FIG. 1 is an external structure schematic view of the multi-layer ceramic capacitor with three terminals in the prior art;

FIG. 2a-2c are structure schematic views of inner electrode of capacitor according to the embodiment of the present invention;

FIG. 3 is an external structure schematic view of the capacitor according to the embodiment of the present invention; FIGS. 4a and 4b are printed schematic views of inner electrode of capacitor according to the embodiment of the present invention;

FIG. 5a-5d are schematic views of wiring of capacitor according to the embodiment of the present invention.

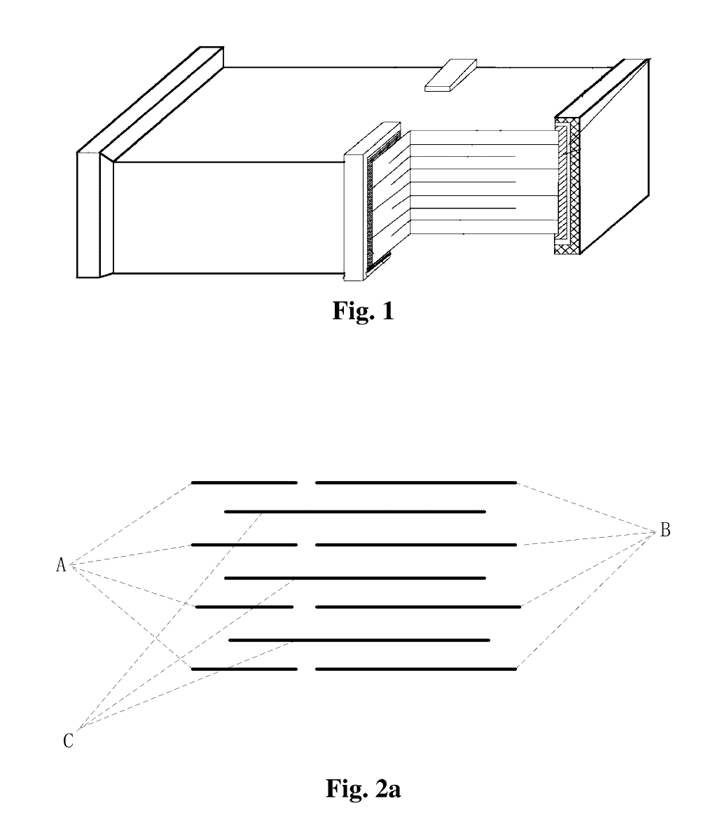

### DETAILED DESCRIPTION OF THE PREFERRED EMBODIMENTS

### Embodiment 1

The capacitor with various capacitances as one embodiment of the present invention, comprising dielectric sheets, outer electrodes, and inner electrodes, wherein the inner electrodes are printed on the dielectric sheets, the dielectric sheets are overlapped, the odd layers of the dielectric sheets are first dielectric sheets, and the even layers of the dielectric sheets are second dielectric sheets, and the first dielectric sheets and the second dielectric sheets are provided oppositely to form the capacitor. The inner electrode on the first dielectric sheet is divided into two isolated electrodes, each electrode on the first dielectric sheet and the inner electrode on the second dielectric sheet is leaded respectively to form terminal electrodes. Since there are three leading terminals, three terminal electrodes are formed, and the terminal electrodes are encapsulated to form the outer electrodes. Wherein, any two outer electrodes can be used as two terminals of the capacitor, or connecting two of the outer electrodes and then the other out electrode are used as two terminals of the capacitor, thus various capacitances according to the needs can be formed by the combination of outer electrodes. In other embodiments, the inner electrodes on the first dielectric sheet and the second dielectric sheet may be divided into multi-section isolated electrodes, such as dividing the first dielectric sheet into two section, dividing the second dielectric sheet into three section, etc., as long as the first dielectric sheets and the second dielectric sheets are provided oppositely to form the capacitor, and the electrodes are easily to be leaded.

As other alternative embodiments, the inner electrode on the first dielectric sheet can be a complete electrode, the inner electrode on the second dielectric sheet may be divided into two isolated electrodes, and then the electrode on the first dielectric sheet is leaded, and two electrodes on the second dielectric sheet are leaded respectively, since there are three leading terminals, three terminal electrodes are formed, and the terminal electrodes are encapsulated to form the outer electrodes.

In the light of the above inventive concept, the inner electrodes on the first dielectric sheet and the second dielectric sheet may be divided into two (the two sections should be overlapped, in order to form capacitor) or more sections, then electrodes are respectively leaded out. It should be noted that, with the increasing number of sections that the inner electrode divided, the processing of inner electrode and the leading terminal electrodes will become more and more complex, therefore, generally, only the inner electrode on first dielectric sheet or the second dielectric sheet is divided into two electrodes with different lengths, which forms three terminal electrodes, and a capacitor with four capacitances can be formed by connecting any two terminal electrodes and then selecting the other electrode. However, in the light of the inventive concept of the present invention, a capacitor with more terminal electrodes and more capacitances can be formed.

The capacitor in the present embodiment, the inner electrode on the first dielectric sheet and/or an inner electrode on the second dielectric sheet is divided into at least two isolated electrodes, each electrode on the first dielectric sheet and the second dielectric sheet is leaded respectively to form terminal electrodes, and the terminal electrodes are encapsulated to form the outer electrodes. Thus, different outer electrodes for wiring can be selected according to the needs for capacitor capacitances, in order to provide various capacitances, only by changing wiring on one capacitor, which can meet the needs of customers for different capacitances, with a good versatility, and a wide application range; meanwhile, since various capacitances are achieved on one capacitor, thus, such a capacitor can replace several capacitors in the circuit (especially suitable for circuits that require various capacitances, such as decoupling or filtering circuits), which greatly reducing the size of the circuit board and the user's inventory pressure.

On the basis of the above technical solutions, the total length of the inner electrode printed on the first dielectric sheet is larger than that of the inner electrode printed on the second dielectric sheet in longitudinal direction, wherein the inner electrode on the first dielectric sheet is divided into two isolated electrodes with different lengths or same length, preferably, the inner electrode on the first dielectric sheet is divided into two isolated electrodes, while the inner electrode printed on the second dielectric sheet can be communicated.

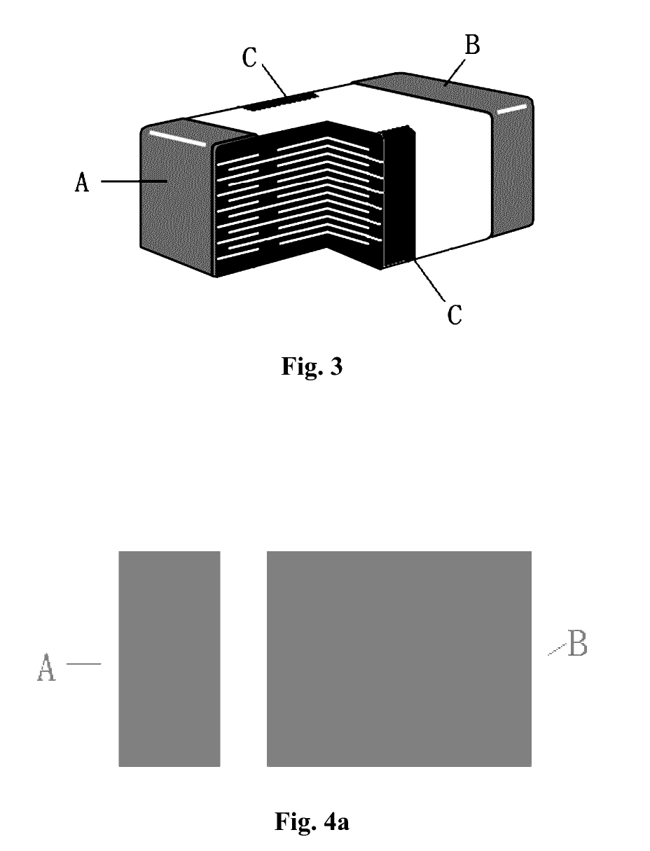

On the basis of the above technical solutions, the two isolated electrodes printed on the first dielectric sheet may be leaded from the terminals of the capacitor in length direction toward the both ends of the length direction; the inner electrode printed on the second dielectric sheet may be leaded from the waist portion of the capacitor in the length direction toward both ends of the width direction. For the convenience of leading, the inner electrode printed on the second dielectric sheet has a cross-shaped structure, the printed view of which is shown in FIG. 4b. The purpose of such design is to lead the terminal electrodes easily, and provide an artistic capacitor with a lower process difficulty. FIG. 3 is an external structure schematic view of the capacitor designed according to this method, wherein the two isolated electrodes printed on the first dielectric sheet are leaded from the terminals of the capacitor in the length direction toward the both ends of the length direction to form terminal electrode A and terminal electrode B, and the inner electrode printed on the second dielectric sheet is leaded from the waist portion of the capacitor in the length direction toward both ends of the width direction to form a terminal electrode, since the inner electrode printed on the second dielectric sheet can be communicated, the two terminal electrodes leaded to the width direction can be communicated, which is shown as terminal electrode C in FIG. 3.

On the basis of the above technical solutions, the first dielectric sheet and the second dielectric sheet can be ceramic dielectric sheets. The outer electrode comprises a base metal layer, a barrier layer, and a weldable layer from the inside to the outside.

In the capacitor of the present invention, through the special design of inner electrodes and the terminal electrodes, various capacitances can be realized in a single capacitor by choosing different outer electrodes (terminal electrodes) as the both terminals of the capacitor. The method of overlapping multilayer for the traditional multi-layer ceramic capacitor is still used in overlapping of the dielectric sheets, and the design of inner electrodes and the terminal electrodes are changed, which is simple to design and convenient to produce.

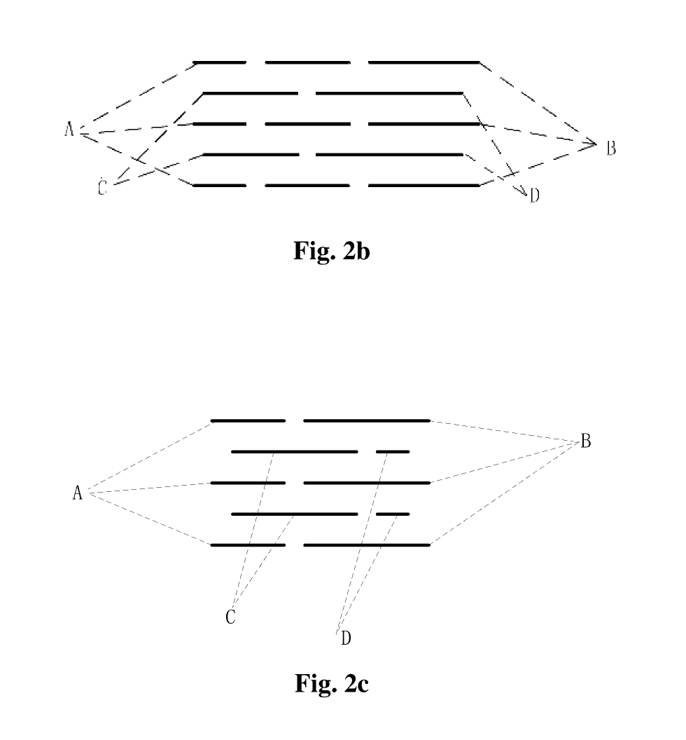

As one embodiment, FIG. 2a shows the inner electrode structure of a capacitor with 7 layers of dielectric sheets, FIG. 3 shows the outer structure of the capacitor with the inner electrode structure, wherein the total length of the inner electrode printed on the first dielectric sheet is larger than that of the inner electrode printed on the second dielectric sheet on the length direction. For convenience of description, the inner electrode printed on the first dielectric sheet can be referred to as long terminal electrode, and the inner electrode printed on the second dielectric sheet can be referred to as short terminal electrode, wherein the long terminal electrode is divided into two isolated electrodes with different lengths, and terminal electrode A and terminal electrode B are leaded from the both isolated electrodes, the printed schematic views thereof are shown in FIGS. 4a and 4b, the wiring of terminal electrode A, terminal electrode B and terminal electrode C can be chosen according to the need of capacitances. The capacitor designed in the present embodiment has four capacitances:

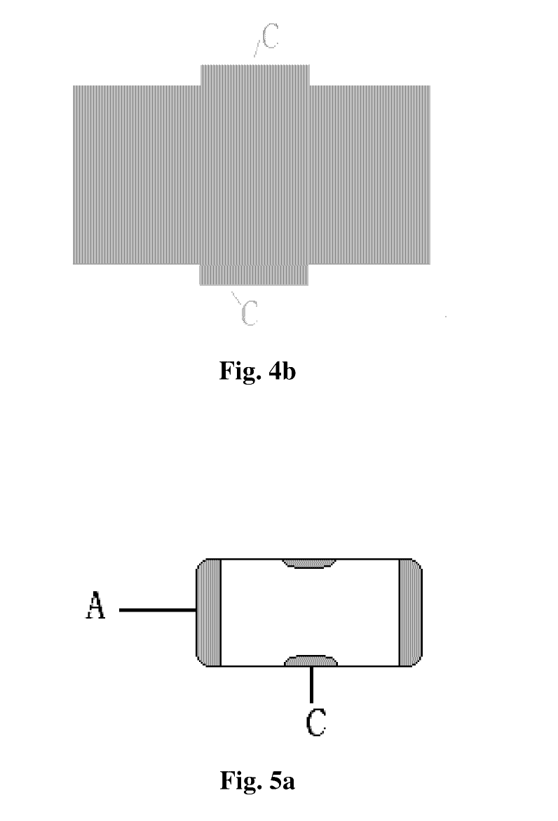

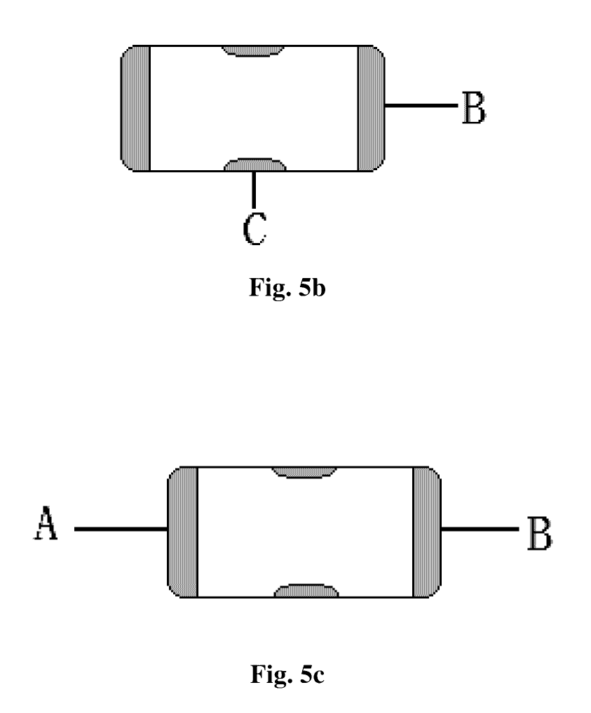

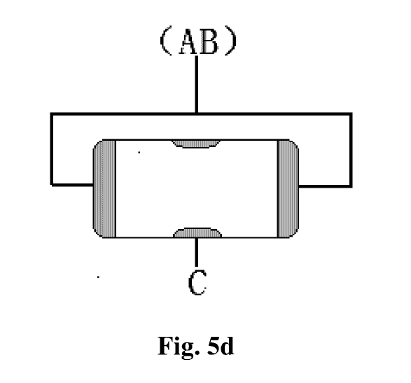

(1) as shown in FIG. 5a, the capacitor C_{AC} is formed by choosing terminal electrode A and terminal electrode C;

(2) as shown in FIG. 5b, the capacitor C_{BC} is formed by choosing terminal electrode B and terminal electrode C;

(3) as shown in FIG. 5c, the capacitor C_{AB} is formed by choosing terminal electrode A and terminal electrode B, wherein the capacitance of capacitor C_{AB} is equal to the series capacitance of capacitor C_{AC} and C_{BC}, that is,

$${C}_{AB} = \frac{{C}_{AC} \times {C}_{BC}}{{C}_{AC} + {C}_{BC}} ,$$

at the same time, since the capacitor C_{AB} is obtained by connecting capacitor C_{AC} and C_{BC} in series, capacitor C_{AB} can withstand higher rated voltage than capacitor C_{AC} and C_{BC};

(4) as shown in FIG. 5d, after connecting terminal electrode A and terminal electrode B, capacitor C_{(AB)C} is formed by choosing terminal electrode AB and terminal electrode C, wherein the capacitance of C_{(AB) C} is equal to the shunt capacitance of capacitor C_{AC} and C_{BC}, that is, C_{(AB)C}=C_{AC}+C_{BC}.

When the long terminal electrode is divided into two isolated electrodes with same length, C_{AC}=C_{BC}, C_{AB}=0.5C_{AC}, C_{(AB) C}=2C_{AC}.

As another embodiment, FIG. 2b shows inner electrode structure of a capacitor with 5 layers of dielectric sheets, wherein the inner electrode on the first dielectric sheet is divided into three electrodes with different lengths, terminal electrode A is leaded form the leftmost electrode, and terminal electrode B is leaded form the rightmost electrode; the inner electrode on the second dielectric sheet is divided into two electrodes electrode, which are leaded form the width direction to form terminal electrode C and terminal electrode D, the wiring of terminal electrode A, terminal electrode B, terminal electrode C and terminal electrode D can be selected according to the needs for capacitor capacitances (wherein, the reason for not leading the middle electrode of the inner electrode on the first dielectric sheet is that: since the capacitor only has two ends on the length direction, it is inconvenient to lead the middle electrode, thus the middle electrode is not leaded), the capacitor in the present embodiment has twelve capacitances: capacitor C_{AB}, capacitor C_{AC}, capacitor C_{AD}, capacitor C_{BC}, capacitor C_{BD}, capacitor C_{CD}, capacitor C_{C (AB)}, capacitor C_{D (AB)}, capacitor C_{C(AD)}, capacitor C_{D(BC)}, capacitor C_{(AD) (BC)} and capacitor C_{(AB) (CD)}.

In fact, FIG. 2c is expectable in the inspiration of FIG. 2b only by overlapping the first dielectric sheet and the second dielectric sheet to form a capacitor, and only the composition form of capacitances after wiring the terminal electrodes is changed.

In other embodiments, the inner electrode on the second dielectric sheet can be divided into more electrodes, such as three or four electrodes, a multiply of electrodes can be leaded from the width direction to form more composition of capacitor according to the needs.

Obviously, the above mentioned embodiments are for clearly explaining the present invention, which do not constitute undue limitation of the present invention. It is obviously to the skilled person in the art that, various modifications could be derived on the basis of the above description, and there is no need to exhaust all the embodiments. Therefore, the modifications or alternations derived thereof are still included in the protection scope of the present invention.

What is claimed is:

1. A capacitor with various capacitances, comprising
dielectric sheets,
outer electrodes, and
inner electrodes, printed on said dielectric sheets,
wherein,
said dielectric sheets are arranged in overlapped manner, odd layers of said dielectric sheets are defined as first dielectric sheets, and even layers of said dielectric sheets are defined as second dielectric sheets,
an inner electrode on said first dielectric sheet and/or an inner electrode on said second dielectric sheet is divided into at least two isolated electrodes, each electrode on said first dielectric sheet and said second dielectric sheet is leaded respectively to form terminal electrodes, and said terminal electrodes are encapsulated to form the outer electrodes.

2. The capacitor of claim 1, wherein,
an inner electrode on said first dielectric sheet is divided into two isolated electrodes.

3. The capacitor of claim 1, wherein,
an inner electrode on said first dielectric sheet is divided into two isolated electrodes with different lengths.

4. The capacitor of claim 1, wherein,
the total length of the inner electrode printed on said first dielectric sheet is larger than that of the inner electrode printed on said second dielectric sheet.

5. The capacitor of claim 2, wherein,
the two isolated electrodes printed on said first dielectric sheet are leaded from the terminals of the capacitor in the length direction towards both ends of the length direction.

6. The capacitor of claims 2, wherein,
the inner electrode printed on said second dielectric sheet is leaded from the waist portion of the capacitor in the length direction towards both ends of the width direction.

7. The capacitor of claim 2, wherein,
the inner electrode printed on said second dielectric sheet has a cross-shaped structure.

8. The capacitor of claim 1, wherein,
said first dielectric sheet and said second dielectric sheet are ceramic dielectric sheets.

9. The capacitor of claim 1, wherein,
said outer electrode comprises a base metal layer, a barrier layer, and a weldable layer from the inside to the outside.
